(19) United States
(12) Patent Application Publication
(10) Pub. No.: US 2007/0240926 A1
(43) Pub. Date: Oct. 18, 2007

(54) Exhaust device and understructure of vehicle

(76) Inventors: Sung Soo Chae, Suwon-city (KR); Hooinyun Kim, Gunpo-city (KR); Hochan Ah, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/606,568

(22) Filed: Nov. 30, 2006

(30) Foreign Application Priority Data
Apr. 18, 2006 (KR) 10-2006-0034855

(51) Int. Cl. B60K 13/04

(52) U.S. Cl. 180/309

(57) ABSTRACT

An exhaust device for a vehicle, the vehicle including a vehicle body, a fuel tank protruding from a bottom surface of the vehicle body, and a suspension system that supports first and second rear wheels to the vehicle body. The exhaust device is configured to be connected to a gas exhaust through-hole of an engine and includes a muffler that is disposed laterally alongside the fuel tank, with a length direction of the muffler disposed along a longitudinal direction of the vehicle body; a first exhaust pipe that connects an exhaust port of the engine to the muffler; and a second exhaust pipe connected to the muffler, and comprising a free end through which exhaust gas is exhausted. The number of mufflers is exactly one.

### CROSS-REFERENCE TO RELATED APPLICATION

This application claims priority to and the benefit of Korean Patent Application No. 10-2006-0034855 filed in the Korean Intellectual Property Office on Apr. 18, 2006, the entire contents of which are incorporated herein by reference.

### BACKGROUND OF THE INVENTION

(a) Field of the Invention

The present invention relates to an understructure of a vehicle on which an exhaust device is mounted, and to an exhaust device with exactly one muffler.

(b) Description of the Related Art

In general, a fuel tank, a suspension system, and an exhaust apparatus are mounted at a bottom of a vehicle. The fuel tank projects from a lower surface of the vehicle. The exhaust device includes a catalytic converter, a center muffler, a main muffler, a first exhaust pipe connecting an exhaust port of the engine to the catalytic converter, a second exhaust pipe connecting the catalytic converter to the center muffler, a third exhaust pipe connecting the center muffler to the main muffler, and a fourth exhaust pipe, one end of which is connected to the main muffler, and the other end of which is positioned near a rear end of the vehicle body.

Resistance of exhaust gas increases while the exhaust gas passes through the two mufflers, and output of the engine may be decreased by such an increased resistance.

In addition, part of the third exhaust pipe is disposed on a lower surface of the fuel tank, and is thus prone to be impacted on the ground. Life of the third exhaust pipe may be shortened by such an impact.

Another part of the third exhaust pipe is disposed between the lower surface of the vehicle and the upper end of the suspension system. Since the third exhaust pipe is sharply bent to accomplish this disposition, manufacturing cost is high and the output of the engine may be deteriorated.

In addition, the main muffler is positioned between the suspension system and the rear end of the vehicle body. Since the length between the suspension system and the rear end of the vehicle body varies with vehicle type, the main muffler must be specifically designed for each vehicle type.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a vehicle with improved engine output and decreased exhaust noise.

A vehicle according to an exemplary embodiment of the present invention includes a vehicle body; a fuel tank located below a rear seat and protruding from a bottom surface of the vehicle body; a suspension system that supports first and second rear wheels to the vehicle body; and an exhaust device connected to a gas exhaust through-hole of an engine and extending to a rear end of the vehicle body, wherein the exhaust device may comprise a muffler located laterally alongside the fuel tank, and disposed along a longitudinal direction of the vehicle body, a first exhaust pipe that connects an exhaust port of the engine to the muffler, and a second exhaust pipe connected to the muffler and extending to the rear end of the vehicle body. The number of mufflers included in the exhaust device may be exactly one.

An inlet of the muffler may be located toward a front end of the vehicle body, and an outlet of the muffler may be located toward a rear end of the vehicle body.

In addition, a gap between a first edge of the vehicle body and an edge of the muffler may have the same size as a gap between a second edge of the vehicle body and an edge of the fuel tank.

The muffler may be configured and dimensioned such that the fuel tank extends beyond the muffler in forward, rearward, and downward directions.

The muffler may include a case forming an inner space; a plurality of partitions dividing the inner space into several portions; and a plurality of inner pipes penetrating the plurality of partitions in the longitudinal direction of the vehicle body. One of the inner pipes may have a first end connected to the second exhaust pipe and a second end which is bent.

The second exhaust pipe and the inner pipe that is connected thereto may be integrally formed.

The suspension system may include a first supporting member that supports the first rear wheel; a second supporting member that supports the second rear wheel; a cross member connecting the first supporting member to the second supporting member; a first link member with a first end connected to a lower part of the first supporting member and a second end connected to a first predetermined portion on the cross member; and a second link member with a first end connected to a lower part of the second supporting member and a second end connected to a second predetermined portion on the cross member. The second exhaust pipe may pass through a bottom surface of the cross member.

The first predetermined portion on the cross member may be located between ⅓ and ⅔ of the distance from a center of the cross member to the first rear wheel, and the second predetermined portion on the cross member may be located between ⅓ and ⅔ of the distance from the center of the cross member to the second rear wheel.

The first predetermined portion on the cross member may be located at the halfway point from the center of the cross member to the first rear wheel, and the second predetermined portion on the cross member may be located at the halfway point from the center of the cross member to the second rear wheel.

The second exhaust pipe may be located between the height of the bottom surface of the cross member and the height of the bottom surface of the fuel tank.

### BRIEF DESCRIPTION OF THE DRAWINGS

FIG. 1 is a bottom plan view showing a bottom surface of a vehicle according to an exemplary embodiment of the present invention.

FIG. 2 is a cross-sectional view taken along line “II-II” in FIG. 1.

FIG. 3 is a graph showing noise from a vehicle according to an exemplary embodiment of the present invention in comparison with noise from a conventional vehicle.

FIG. 4 is a cross-sectional view of a muffler included in a vehicle according to an exemplary embodiment of the present invention.

FIG. 5 is a drawing showing change of overall length of a vehicle body by a vehicle type according to an exemplary embodiment of the present invention.

FIG. 6 is a cross-sectional view taken along line “VI-VI” in FIG. 1.

### DETAILED DESCRIPTION OF THE PREFERRED EMBODIMENTS

The present invention will be described more fully hereinafter with reference to the accompanying drawings, in which exemplary embodiments of the invention are shown. As those skilled in the art will realize, the described embodiments may be modified in various different ways, all without departing from the spirit or scope of the present invention.

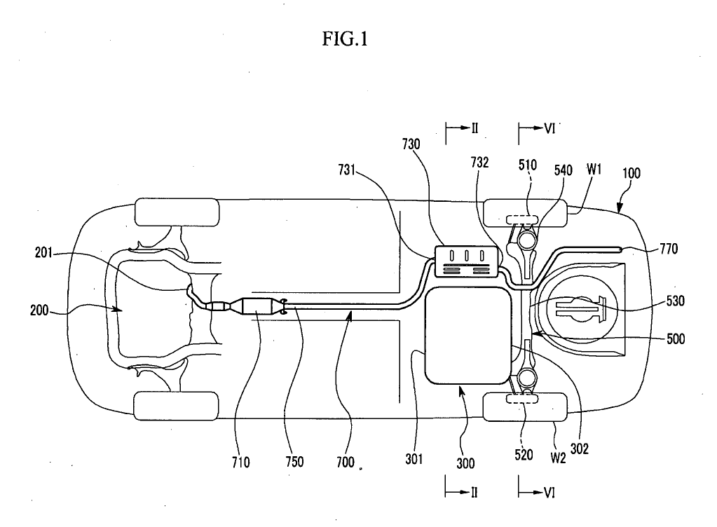

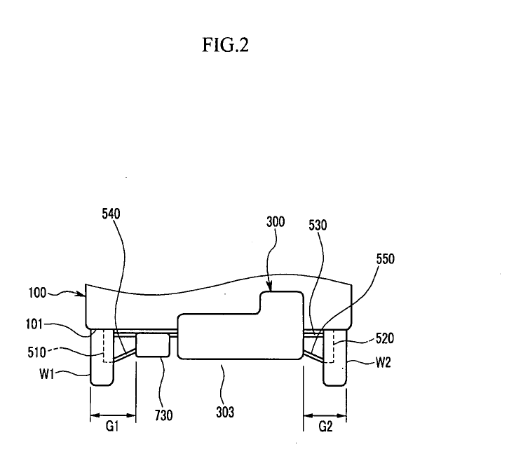

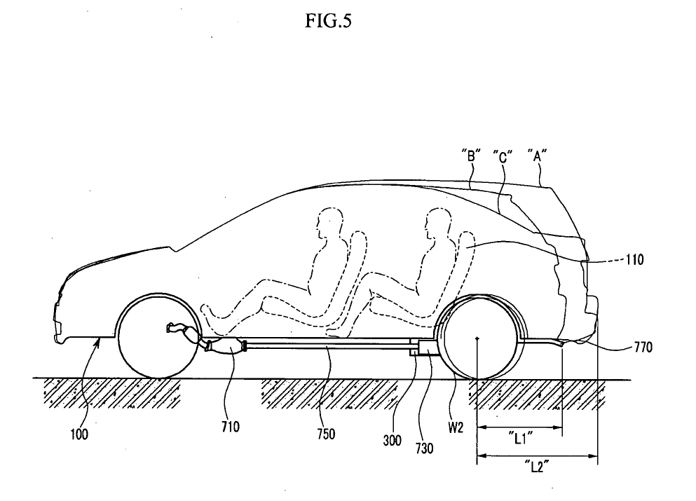

As shown in FIG. 1 and FIG. 2, a fuel tank 300 is located below a rear seat 110 (FIG. 5) of the vehicle, and protrudes from a bottom surface 101 of a vehicle body 100. The suspension system 500 supports first and second rear wheels W1 and W2 to the vehicle body 100. The exhaust device 700, which is connected to a gas exhaust through-hole 201 of an engine 200, and extends to a rear end of the vehicle body 100, discharges exhaust gas to a rear end of the vehicle body 100.

Referring to FIG. 1, the exhaust device 700 includes a first exhaust pipe 750 connected between the gas exhaust through-hole 201 and a muffler 730, and a second exhaust pipe 770, connected to the muffler 730, extends to the rear end of the vehicle body 100.

The catalytic converter 710 is connected to the gas exhaust through-hole 201, and purifies exhaust gas.

The muffler 730, which is located at a lateral side of the fuel tank 300 and disposed along a longitudinal direction of the vehicle body 100, decreases noise. In some embodiments, only one muffler 730 is provided. Output of the engine can be improved by the decreased resistance of exhaust gas obtained by providing only one muffler 730.

When only one muffler 730 is included, a mounting position of the muffler 730 is important in order to effectively decrease exhaust noise. According to experiments, when muffler 730 is provided laterally alongside the fuel tank 300 and disposed along a longitudinal direction of the vehicle body 100 as described above, exhaust noise can be effectively decreased.

It is further preferable that an inlet of the muffler is located toward a front end of the vehicle body 100, and that an outlet of the muffler is located toward the rear end of the vehicle body 100.

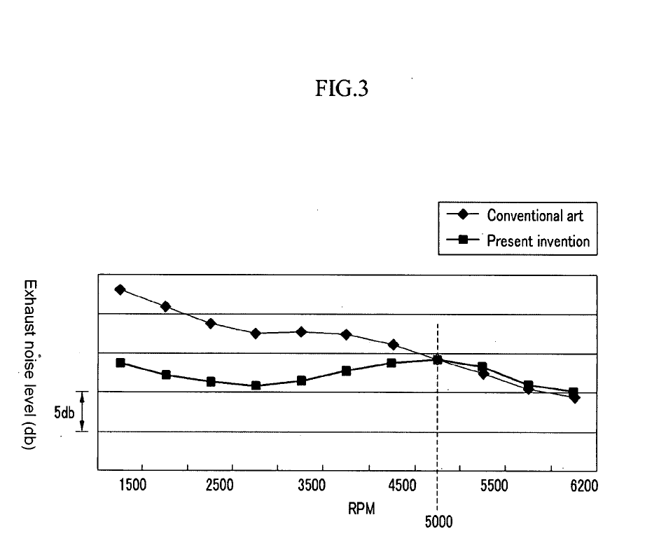

As shown in FIG. 3, results of experiments using the muffler 730 disposed as described above show that an exhaust system according to an exemplary embodiment of the present invention decreases exhaust noise more than a conventional muffler when engine speed is 5000 RPM or less, but that it creates nearly the same amount of exhaust noise with the conventional muffler when engine speed is higher than 5000 RPM.

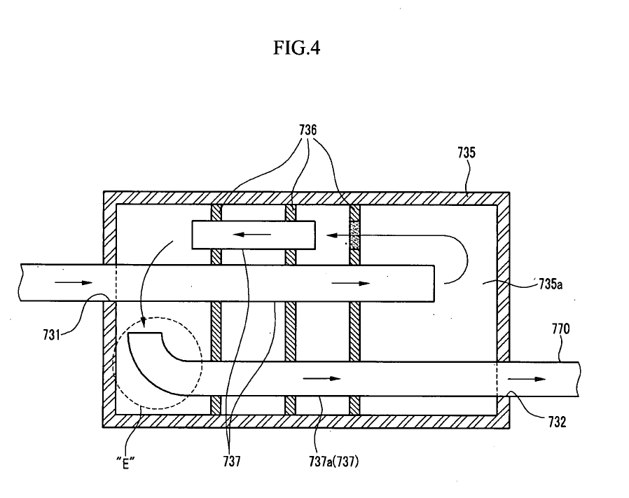

Furthermore, as shown in FIG. 4, the muffler 730 may include a case 735 forming an inner space 735a, a plurality of partitions 736 dividing the inner space 735a into several portions, and a plurality of inner pipes 737 penetrating the partitions 736 in the longitudinal direction of the vehicle body 100. Therefore, exhaust gas may have less noise during passing through the several divided inner spaces, and it is finally discharged through the second exhaust pipe 770 at the outlet 732 of the muffler 730. Particularly, an inner pipe 737a is connected to the second exhaust pipe 770, and it is preferable that the inner pipe 737a has a bent end as shown at E in FIG. 4. When the inner pipe 737a has the bent end, length of the inner pipe can be resultantly extended, and noise can be more decreased because flow of exhaust gas is delayed as much as the extended length of the inner pipe. Particularly, when the inner pipe having the bent end is included in the muffler wherein sound pressure is high, noise can be further decreased. In addition, the second exhaust pipe 770 and the inner pipe 737a connected thereto may be integrally formed as a single member in order for the muffler to have a simple scheme.

As shown in FIG. 5, when a single muffler 730 is provided at the lateral side of the fuel tank 300, an expensive muffler need not be additionally designed because only the length of the second exhaust pipe 770 needs to be adjusted based on vehicle type even though lengths (refer to L1, L2) between the suspension system 500 and the rear end of the vehicle body 100 vary with vehicle type, such as a first vehicle type A, a second vehicle type B, and a third vehicle type C.

In addition, referring to FIG. 2, a gap G1 between the left edge of the vehicle body 100 and the left edge of the muffler 730 may have the same dimensions as a gap G2 between the right edge of the vehicle body 100 and the right edge of the fuel tank 300 in order to simplify the bottom of a vehicle.

Referring to FIG. 1, the muffler 730 may be located between a front side 301 and rear side 302 of the fuel tank 300. In addition, referring to FIG. 2, the muffler 730 may be also located between the bottom surface 101 of the vehicle body 100 and the bottom surface 303 of the fuel tank 300. When the muffler 730 is located in the position described in the above, the fuel tank 300 can protect the muffler 730 from external impacts when the bottom of the vehicle body collides with the ground.

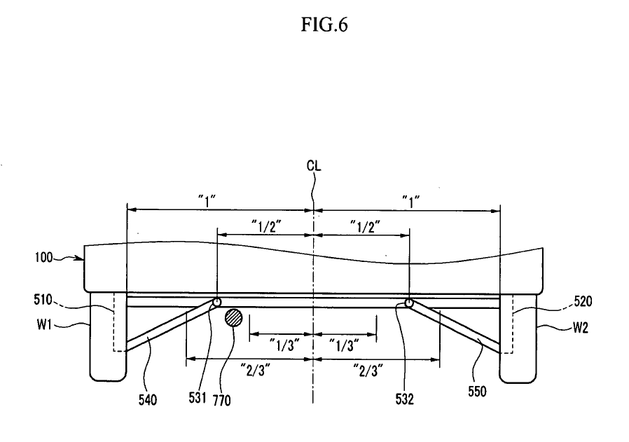

Referring to FIGS. 1 and 6, the suspension system 500 may include a first supporting member 510, which supports a first rear wheel (W1), and a second supporting member 520, which supports a second rear wheel (W2).

The suspension system 500 may further include a cross member 530, which connects the first supporting member 510 to the second supporting member 520.

The suspension system 500 may further include a first link member 540, one end of which is connected to a lower part of the first supporting member 510, and another end of which is connected to a first predetermined portion 531 on the cross member 530; and a second link member 550, one end of which is connected to a lower part of the second supporting member 520, and another end of which is connected to a second predetermined portion 532 on the cross member 530.

The second exhaust pipe 770 passes through a bottom surface of the cross member 530. It is preferable that one end of the first link member 540 and one end of the second link member 550 are connected to the cross member in the following scheme in order for the second exhaust pipe 770 to pass through the bottom surface of the cross member 530.

The first predetermined portion 531 may be located between ⅓ and ⅔ of the distance from the center CL of the cross member 530 to the first rear wheel (WI). In addition, the second predetermined portion 532 may be located between ⅓ and ⅔ of the distance from the center CL of the cross member 530 to the second rear wheel (W2). Therefore, the second exhaust pipe 770 can pass between the first predetermined portion 531 on the bottom surface of the cross member 530 and the center CL of the cross member 530.

In some embodiments, the first predetermined portion 531 is located at the halfway point from the center CL of the cross member 530 to the first rear wheel (W1). In addition, the second predetermined portion 532 is located at the halfway point from the center CL of the cross member 530 to the second rear wheel (W2).

As described above, a vehicle according to an exemplary embodiment of the present invention may provide the following advantages.

Since only one muffler is included, output of engine can be improved, and manufacturing cost of the engine can be reduced. In addition, since the muffler is located at an optimal place, exhaust noise may be decreased. Furthermore, an expensive muffler need not be specifically designed for each vehicle type.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An exhaust device for a vehicle, the vehicle comprising a vehicle body; a fuel tank protruding from a bottom surface of the vehicle body; and a suspension system that supports first and second rear wheels to the vehicle body; the exhaust device configured to be connected to a gas exhaust through-hole of an engine and comprising:
a muffler that is disposed laterally alongside the fuel tank, wherein a length direction of the muffler is disposed substantially along a longitudinal direction of the vehicle body;
a first exhaust pipe that connects an exhaust port of the engine to the muffler; and
a second exhaust pipe connected to the muffler, and comprising a free end through which exhaust gas is exhausted;
wherein the muffler is exactly one muffler.

2. The exhaust device of claim 1, wherein an inlet of the muffler is located toward a front end of the vehicle body, and an outlet of the muffler is located toward a rear end of the vehicle body.

3. The exhaust device of claim 1, wherein a first gap between a first edge of the vehicle body and an edge of the muffler has a size substantially equal to a size of a second gap between a second edge of the vehicle body and an edge of the fuel tank.

4. The exhaust device of claim 1, wherein the muffler is configured and dimensioned such that the fuel tank extends beyond the muffler in forward and rearward directions.

5. The exhaust device of claim 1, wherein the muffler is configured and dimensioned such that the fuel tank extends beyond the muffler in a downward direction.

6. The exhaust device of claim 1, wherein the muffler comprises:
a case comprising an inner space;
at least one partition dividing the inner space into a plurality of portions; and
at least one inner pipe penetrating the partitions in the longitudinal direction of the vehicle body, and wherein
one of the inner pipes comprises a first end connected to the second exhaust pipe; and a second end, which is bent.

7. The exhaust device of claim 6, wherein the second exhaust pipe and the inner pipe connected thereto are integrally formed.

8. The exhaust device of claim 1, wherein the suspension system comprises:
a first supporting member that supports the first rear wheel;
a second supporting member that supports the second rear wheel;
a cross member connecting the first supporting member to the second supporting member;
a first link member comprising a first end connected to the first supporting member and a second end connected to a first predetermined portion on the cross member; and
a second link member comprising a first end connected to the second supporting member and a second end connected to a second predetermined portion on the cross member;
wherein the second exhaust pipe passes through the cross member.

9. The exhaust device of claim 8, wherein a first distance D₁ between a center of the cross member and the first rear wheel is substantially equal to a distance between the center of the cross member and the second rear wheel, the first predetermined portion is located at a second distance D₂ from the center of the cross member, and the second predetermined portion is located at a third distance D₃ from the center of the cross member; and wherein:
D₁/3<≈D₂<≈2D₁/3; and
D₁/3<≈D₃<≈2D₁/3.

10. The exhaust device of claim 9, wherein the second exhaust pipe is located between a height of the bottom surface of the cross member and a height of the bottom surface of the fuel tank.

11. The exhaust device of claim 9, wherein D₂≈D₃≈D₁/2

12. The exhaust device of claim 11, wherein the second exhaust pipe is located between a height of the bottom surface of the cross member and a height of the bottom surface of the fuel tank.
